(19) United States
(12) Patent Application Publication
(10) Pub. No.: US 2026/0249808 A1
(43) Pub. Date: Aug. 27, 2026

(54) FORCE LIMITER

(71) Applicant: Autoliv Development AB, Vargarda (SE)

(72) Inventors: Roald LINGBEEK, Hamburg (DE); Ole SCHARNBERG, Hamburg (DE); Michel HERMANN, Pinneberg (DE); Günter CLUTE, Elmshorn (DE); Dietmar LEGDE, Hamburg (DE); Leif SCHATTAUER, Elmshorn (DE)

(21) Appl. No.: 19/134,062

(22) PCT Filed: Nov. 28, 2023
(86) PCT No.: PCT/EP2023/083349

§ 371 Date: May 29, 2025

(30) Foreign Application Priority Data
Nov. 29, 2022 (DE) 10 2022 131 560.6

(51) Int. Cl. B60R 22/28

(52) U.S. Cl. CPC B60R 22/28

(57) ABSTRACT

A force limiter for a seat belt of a seat belt device of a motor vehicle, having —a fitting part, —a deformation tube, —a tensile transmission element, and —a displacement part which is connected to the tensile transmission element with tension resistance and is arranged in or on the deformation tube, wherein —the deformation tube has a linear portion, in or at the open end of which the displacement part is held, wherein —the deformation tube has a deflection portion formed integrally with the linear portion in which the tensile transmission element is deflected.

The present invention relates to a force limiter having the features of the preamble of claim 1.

Seat belt devices are generally used to restrain vehicle occupants in the event of an accident. For this purpose, the seat belt devices have a seat belt which can be wound up with a first end on a belt reel of a belt retractor which is rotatably mounted in a frame which can be fixed to the vehicle. To create a 2-point belt, the seat belt can be provided with a belt tongue at its second end, which can be locked in a belt buckle fixed to the vehicle. Furthermore, in order to implement a 3-point belt, the seat belt can be fastened at its second end by means of an end fitting on the same side of the vehicle seat as the belt retractor, wherein a movable belt tongue is provided on the seat belt, which can be locked in a belt buckle fastened on the other side of the vehicle seat in order to divide the seat belt into the 3-point geometry.

The belt reel in the belt retractor is pre-tensioned in the winding direction by a mainspring supported on the frame, so that the seat belt is automatically wound up after the belt tongue is unlocked. Furthermore, a blocking device with associated sensor devices is provided which blocks the belt reel against further rotation in the direction of extension of the seat belt if predetermined values of the belt webbing extension acceleration and/or vehicle deceleration are exceeded. This means that if the belt reel is blocked, the occupant is restrained by the seat belt and protected from impact with the internal vehicle structure.

Furthermore, modern vehicles are also equipped with airbags, which can be arranged at various points on the vehicle structure and are inflated to cover the vehicle structure in the event of an accident. The occupant is restrained by a combination of the seat belt device and the provided airbags.

Since the occupants are additionally protected from impact with the vehicle structure by the inflated airbags, it may be advisable to provide additional force limiters in the seat belt device, which allow force-limited belt webbing extension when the belt reel is blocked. The force limiters can be assigned to the belt buckle, the end fitting, a deflection device, the fastening of the belt retractor or the belt reel.

From the document DE 10 2017 101 807 A1, a force limiter is known which is arranged on an end fitting or on a belt buckle and comprises a straight deformation tube with a displacement part provided therein, wherein the displacement part is connected to a tensile transmission means in the form of a cable, which in turn is connected to a belt transmission means in the form of a belt buckle or a cable loop. The seat belt is thus connected directly or indirectly via the belt transmission means to the tensile transmission means and, via the latter, to the displacement part.

In the event that the plastic deformation limit of the deformation tube is exceeded by the tensile force exerted on the displacement part, the displacement part is pulled through the deformation tube under a plastic deformation of the deformation tube and thus enables a force-limited extension of the seat belt even when the belt reel is blocked.

The deformation tube is formed by a straight tube which is fastened to a fitting at which the tensile transmission means is further deflected. In addition to deflecting the tensile transmission means, the fitting also serves to fasten the force limiter to the vehicle structure. This means that the fastening point of the deformation tube to the fitting is an interface through which the tensile transmission means must pass. In order to ensure the guidance of the tensile transmission means in the region of the interface, an additional connection element is provided, through which the tensile transmission means extends. The connection element is supported on the fitting part and also serves to fasten the deformation tube to the fitting part.

Against this background, the object of the invention is to provide a cost-effective force limiter which should have a simplified structure with a simplified guide of the tensile transmission element.

According to the basic idea of the invention, it is proposed that the deformation tube has a deflection portion formed integrally with the linear portion, in which the tensile transmission element is deflected.

The advantage of the proposed solution is that the deformation tube is used in addition to the deflection of the tensile transmission element, so that the previously required deflection on the fitting part is no longer necessary. This also eliminates the interface and the connection element required to bridge the interface and to fasten the deformation tube to the fitting part. This allows, on the one hand, the costs for manufacturing and assembling the force limiter to be reduced and, on the other hand, the deflection itself to be improved by eliminating the need to deflect the tensile transmission element via the interface.

It is further proposed that the displacement part comprises a deformation portion which is non-round in cross section and has a greater external dimension than the inner diameter of the deformation tube in cross section in at least one extension direction. Due to the non-round cross section of the displacement part in the region of the deformation portion, the deformation of the deformation tube takes place in preferred directions defined by the shape of the deformation portion. The deformation tube is deliberately not expanded evenly over its circumference, and zones are deliberately created in the deformation tube in which it is deformed under higher loads with higher material stresses. This allows the use of cheaper materials or steels without risking the deliberately induced controlled deformation of the deformation tube.

In this case, the non-round deformation portion can preferably have at least two radially outwardly projecting cams in cross section on its radial outer side. The deformation tube is thus deliberately widened in the region of the cams. Furthermore, with a corresponding shape of the deformation tube, the cams can be used to align the displacement part in a defined position relative to the deformation tube. The cams on the side facing the deflection portion or the guide portion of the displacement part can be designed in a ramp-shaped manner with a decreasing outer dimension, so that the deformation of the deformation tube takes place in a rising manner.

It is further proposed that the non-round deformation portion has at least two flattened portions in cross section. The flattened portions deliberately create free spaces between the deformation tube and the displacement part, which allow the deformation tube to be applied or contracted to the displacement part during deformation.

It is further proposed that the cams and/or flattened portions are arranged diametrically opposite each other so that the deformation tube is deliberately widened and deformed in its opposite portions.

Furthermore, the cams and/or flattened portions can be arranged equidistantly from one another over the circumference of the displacement part, so that the deformation tube is deformed as uniformly as possible over the circumference and in the region of the cams in a plastic deformation range that is as equal as possible.

It is further proposed that the displacement part has a cylindrical guide portion which has an outer diameter corresponding to the inner diameter of the deformation tube. The guide portion serves to align the displacement part in the deformation tube in the mounted position and to guide the displacement part during the movement of the displacement part in the deformation tube. The guide portion deliberately has an outer diameter which, taking into account the tolerances to be provided, corresponds to the inner diameter of the deformation tube, so that the displacement part does not cause any deformation of the deformation tube in the region of the guide portion. The guide portion is arranged on the side of the deformation portion which faces the deflection portion.

It is further proposed that the deformation tube comprises at least one radially inwardly shaped bead in the region of the linear portion, which bead limits the displacement path of the displacement part in the deformation tube. The bead limits the displacement movement of the displacement part; it prac-tically forms a stop for the force-limited belt webbing extension.

It is further proposed that the fitting part comprises a fastening portion for fastening the force limiter to a vehicle-fixed structure, a first fixing portion comprising the deformation tube in the region of the linear portion and a second fixing portion comprising the deformation tube in the region of the deflection portion. The design of the fitting part fixes the deformation tube both in the region of the linear portion and in the region of the deflection portion. This fixes the deformation tube in the region of the linear portion to absorb the forces acting on the deformation tube in this region during deformation. In addition, the deformation tube is additionally fixed in the region of the deflection portion to absorb the forces acting during the deflection of the tensile transmission element. Furthermore, the deformation tube is thus fixed in the region where the tensile transmission element exits the deformation tube, which in turn is advantageous for the supply of the tensile transmission element to the seat belt.

It is further proposed that the deformation tube be oval-shaped in the region of the open end of the deflection portion. Due to the oval shape of the open end of the deflection portion, the tensile transmission element cannot be moved or can be moved less in a preferred direction, while it can be deliberately pivoted in the direction of the increased opening width in the range of a larger pivot angle. The force limiter can preferably be fastened to the vehicle in such a way that the tensile transmission element can perform smaller movements transversely to the seat surface of the associated vehicle seat and is thus better aligned than in the longitudinal direction of the seat surface or in the direction of travel.

It is further proposed that at least one additional deformation element or stop element is provided in the deformation tube to realize a progressive or degressive force limitation curve. By means of the additional deformation element or stop element, different force limitation curves can be realized through appro-priate arrangement and dimensioning of the same, provided that this is advantageous for restraint and in particular for a further reduction of the occupant load.

It is further proposed that the position of the deformation element or the stop element can be changed by means of a controllable actuator. This allows the force limitation curve to be actively changed and, for example, adapted to a detected accident scenario or to the specific occupant.

It is further proposed that a blocking element is provided which blocks the displacement part and which can be moved by means of a controllable actuator from a blocking position into a release position which releases the displacement part. This allows the activation of the force limiter to be actively blocked or released.

Alternatively or additionally, it is proposed that a blocking element is provided which blocks the tensile transmission element and which can be moved by means of a controllable actuator from a blocking position into a release position which releases the tensile transmission element. The activation of the force limiter can also be actively blocked or released by blocking or releasing the tensile transmission element.

The invention is explained below using preferred embodiments with reference to the accompanying figures, in which:

FIG. 1 shows a force limiter according to the invention with a belt buckle before assembly; and

FIG. 2 shows the force limiter according to the invention with a belt buckle in side view; and

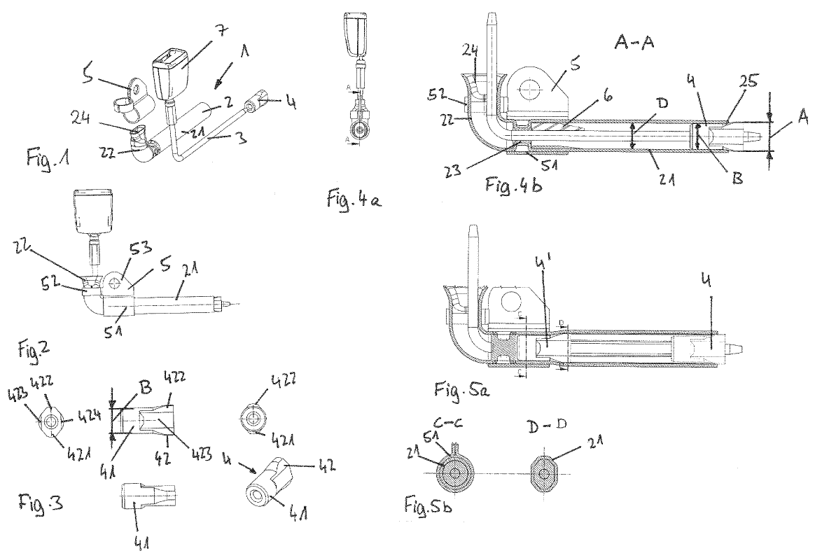

FIG. 3 shows a displacement part of the force limiter in different views; and

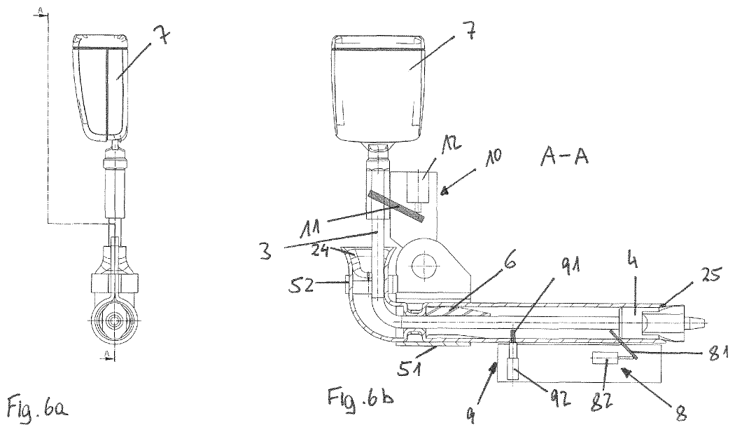

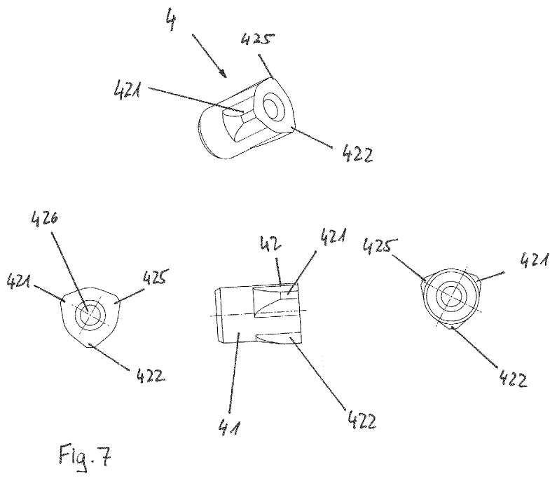

FIG. 4 a,b show the force limiter in view of the displacement part and in sectional view in the section direction A-A of FIG. 4a; and

FIG. 5 a,b show the force limiter with the displacement part in a position before and after the force limitation in different sectional views;

FIG. 6 a,b show the force limiter in sectional view with additional actuators for influencing the activation and the force limitation level;

FIG. 7 shows an alternative embodiment of a displacement part in different views.

FIG. 1 shows an exploded view of a force limiter 1 according to the invention with the individual parts before assembly. The force limiter 1 comprises a deformation tube 2, a tensile transmission element 3, a displacement part 4 and a fitting part 5. The tensile transmission element 3 is connected at one end to the displacement part 4 with tension resistance and at its other end to a belt buckle 7 with tension resistance. Instead of the belt buckle 7, an end fitting, a cable loop, a deflector, or another part of a seat belt device can also be provided, provided that this, in conjunction with the tensile transmission element 3, enables a force-limited extension of the seat belt by the linear movement of the displacement part 4 in the deformation tube 2 described below. The tensile transmission element 3 is a rope, preferably a steel rope, which is inherently flexible and, due to its material properties and design, is able to absorb the tensile forces occurring in the event of restraint without itself tearing or being mechanically destroyed.

The deformation tube 2 has a straight linear portion 21 and a curved deflection portion 22 formed integrally with the linear portion 21. The fitting part 5 serves to fasten the force limiter 1 to the vehicle and for this purpose has a plate-shaped fastening portion 53 with a fastening opening. Furthermore, the fitting part 5 has a first fixing portion 51 and a second fixing portion 52, which are each annular or clamp-like and serve to hold the deformation tube 2 on the fitting part 5, i.e., to hold the deformation tube 2 fixed to the vehicle.

The fitting part 5 comprises the deformation tube 2 with the annular first fixing portion 51 in the region of the linear portion 21 at its end facing the deflection portion 22. The first fixing portion 51 is deliberately dimensioned somewhat longer and thus more tubular in shape, so that the deformation tube 2 finds stable support in the first fixing portion 51. The second fixing portion 52 of the fitting part 5 comprises the deformation tube 2 in the region of the deflection portion 22 and thus additionally fixes the deflection portion 22 relative to the linear portion 21. The deformation tube 2 is thus prac-tically fixed in its geometry by the two fixing portions 51 and 52.

The linear portion 21 of the deformation tube 2 has an open end 25, which can be seen in FIG. 4b, in or on which the displacement part 4 is arranged. The tensile transmission element 3 is connected to the displacement part 4 with tension resistance and extends from the displacement part 4 first through the linear portion 21 of the deformation tube 2 and is then deflected in a predetermined direction in the deflection portion 22 of the deformation tube 2 which is integrally formed on the linear portion 21. The deformation tube 2 is oval-shaped in the region of the open end 24 of the deflection portion 22, so that the tensile transmission element 3 can perform larger movements, in particular pivoting movements, in a preferred direction than in the direction oriented orthogonally to this. The preferred direction can correspond to the direction of travel and/or the longitudinal direction of the seat surface of the associated vehicle seat, so that the belt buckle 7 or the end fitting held on the tensile transmission element 3 can deliberately carry out larger movements in the direction of travel or in the longitudinal direction of the seat surface and is restricted in movement transversely to this direction.

The displacement part 4 has a cylindrical guide portion 41 with a circular cross section and a deformation portion 42 with a non-round cross section. The displacement part 4 further has a through-opening 426 through which the tensile transmission element 3 extends. The tensile transmission element 3 is pressed, glued or connected with tension resistance to the displacement part 4 in the through-opening by a thickening of the protruding end. The guide portion 41 has an outer diameter B which, taking into account an undersize, is identical to the inner diameter D of the linear portion 21 of the deformation tube 2, so that the displacement part 2 with the guide portion 41 can be inserted into the open end 25 and lies as flat as possible against the inner wall of the linear portion 21. The deformation portion 42 is non-round in cross section with two cams 421 and 422 arranged diametrically opposite each other on the radial outer side and equidistant from each other in the circumferential direction and two flattened portions 423 and 424 arranged diametrically opposite each other and equidistant from each other in the circumferential direction. Due to the cams 421 and 422, the deformation portion 42 has an external dimension A which is larger than the inner diameter D of the linear portion 21 of the deformation tube 2. The cams 421 and 422 are formed on their edge sides facing the edge of the deformation tube 2, starting from the guide portion 41, in a ramp-shaped manner rising outwards.

Furthermore, the deformation tube 2 has, on the side of the linear portion 21 facing the deflection portion 22, at least two diametrically opposed radially inwardly projecting or one circumferential bead(s) 23, which are dimensioned such that a gap is formed between their radially inner end faces, through which gap the tensile transmission element 3 extends. The gap formed by the beads 23 serves to guide the tensile transmission element 3 and also to form a stop to limit the movement of the displacement part 4, which will be explained in more detail below, during the force-limited belt webbing extension.

Furthermore, an additional conically tapering deformation element 6 in the form of a plastically deformable material is provided, which extends from the beads 23 in the direction of the open end 25 of the linear portion 21 of the deformation tube 2.

In FIG. 4b, the force limiter 1 can be seen in section direction A-A of FIG. 4a before activation. The displacement part 4 is in a position in which it projects with the guide portion 41 into the linear portion 21 of the deformation tube 2, and the deformation portion 42 is arranged outside the deformation tube 2 in the illustration of FIG. 4b on the right, i.e., outside the open end 25 of the linear portion 21.

If, in this position of the force limiter 1, a tensile force is exerted on the tensile transmission element 3 via the seat belt, which is greater than the plastic deformation limit of the deformation tube 2 in the region of the linear portion 21, the displacement part 4 is pulled from the initial position into the position 4′ shown in FIG. 5a. The deformation tube 2 is expanded in the region of the linear portion 21 by the cams 421 and 422 and is thereby plastically deformed. At the same time, the deformation tube 2 is pulled laterally towards the flattened portions 423 and 424 in this region, as can be seen in the sectional view D-D in FIG. 5b. The deformation tube 2 is thus plastically deformed into a geometry corresponding to the cross-sectional geometry of the deformation portion 42. The deformation portion 42 serves for the plastic deformation of the deformation tube 2 in the region of the linear portion 21, wherein it is not excluded that the deformation portion 42 itself also deforms slightly. The deformation of the linear portion 21 by the cams 421 and 422 takes place in two preferred directions outwards, while at the same time it rests laterally against the flattened portions 423 and 424. The plastic deformation of the deformation tube 2 is the basis for the energy absorption underlying the force-limited extension of the tensile transmission element.

Due to the proposed shape of the displacement part 4, a defined stress state is created during the movement of the displacement part 4 and the force-limited belt webbing extension in the deformation tube 2 during the plastic deformation, which enables an improved defined deformation of the deformation tube 2 to achieve a defined force limitation level even when using less expensive steel or material types. This allows the costs of manufacturing the force limiter 1 to be further reduced.

If, as in the present exemplary embodiment, beads 23 and an additional deformation element 6 are provided, the force-limited extension of the tensile transmission element 3 can firstly be limited and secondly be designed to increase progressively towards the end.

In FIG. 6b, the force limiter 1 can be seen in a further developed embodiment according to the section direction A-A of FIG. 6a.

Various control devices 8, 9 and 10 are provided on the force limiter 1 for controlling the force limiter 1 and its force limitation curve. Thus, a control device 8 is provided which has a blocking element 81 which, in a blocking position, rests against the displacement part 4 and blocks its movement. The control device 8 further comprises an actuator 82 which, upon activation, moves the blocking element 81 from the blocking position into a release position, so that the displacement part 4 is subsequently released to execute the movement described above.

Furthermore, a control device 9 is provided, which has a stop element 91 projecting into the travel path of the displacement part 4 and a controllable actuator 92 which moves the stop element 91 when activated. The stop element 91 can limit the travel path of the displacement part 4 and thus the force-limited belt extension length. Alternatively, the stop element 91 can be used as an additional deformation element, following the example of the conical deformation element 6, which deliberately plastically deforms when passing the displacement part 4 and thus causes an increase in the force limitation level. This allows different force limitation curves to be realized depending on the position of the stop element 91 or deformation element.

Furthermore, a control device 10 is provided which has a blocking element 11 which, in a blocking position, rests against the belt buckle 7 or clamps the end of the tensile transmission element 3. The control device 10 further comprises an actuator 12 which, when activated, moves the blocking element 11 from the blocking position into a release position in which the belt buckle 7 or the tensile transmission element 3 is released.

The control devices 8, 9 and 10 can be provided individually or in any combination on the force limiter 1. The actuators 12, 92 and 82 can be designed either as electrically controllable drives or as pyrotechnic drives with an electrical ignition. In any case, an accident-specific and/or occupant-specific force limitation curve of the force limiter 1 can be set by the control devices 8, 9 and 10.

FIG. 7 shows an alternative embodiment of a displacement part 4 with three cams 421, 422 and 425 arranged in a star shape and equidistantly distributed over the circumference. The three cams 421, 422 and 425 are arranged so that their centers are at angles of 120 degrees to each other. The cams 421, 422 and 425 are shaped in a ramp-shaped manner towards the guide portion 41 at their portions facing the guide portion, so that the cams 421, 422 and 425 deform the deformation tube 2 with an increasing plastic deformation during the force-limited movement.

1. A force limiter for a seat belt of a seat belt device of a motor vehicle, comprising
a fitting part,
a deformation tube,
a tensile transmission element and
a displacement part which is connected to the tensile transmission element with tension resistance and is arranged in or on the deformation tube, wherein
the deformation tube has a linear portion, in or at the open end of which the displacement part is held,
wherein
the deformation tube has a deflection portion formed integrally with the linear portion, in which the tensile transmission element is deflected.

2. The force limiter according to claim 1, wherein
the displacement part comprises a deformation portion which is non-round in cross section and has a greater external dimension (A) than the inner diameter (D) of the deformation tube in cross section in at least one extension direction.

3. The force limiter according to claim 2, wherein
the non-round deformation portion in cross section comprises at least two radially outwardly projecting cams on its radial outer side.

4. The force limiter according to claim 2, wherein
the non-round deformation portions have at least two flattened portions in cross section on their radial outer side.

5. The force limiter according to claim 3, wherein
the cams and/or the flattened portions are arranged diametrically opposite each other.

6. The force limiter according to claim 3, wherein
the cams and/or the flattened portions are arranged equidistantly from one another over the circumference of the displacement part.

7. The force limiter according to claim 1, wherein
the displacement part has a cylindrical guide portion which has an outer diameter (B) corresponding to the inner diameter (D) of the deformation tube.

8. The force limiter according to claim 1, wherein
the deformation tube comprises at least one radially inwardly shaped bead in the region of the linear portion, which bead limits the displacement path of the displacement part in the deformation tube.

9. The force limiter according to claim 1, wherein
the fitting part comprises a fastening portion for fastening the force limiter to a vehicle-fixed structure, a first fixing portion comprising the deformation tube in the region of the linear portion and a second fixing portion comprising the deformation tube in the region of the deflection portion.

10. The force limiter according to claim 1, wherein
the deformation tube is oval-shaped in the region of the open end of the deflection portion.

11. The force limiter according to claim 1, wherein
at least one additional deformation element or stop element is provided in the deformation tube for realizing a progressive or degressive force limitation curve.

12. The force limiter according to claim 11, wherein
the position of the deformation element or of the stop element can be changed by means of a controllable actuator.

13. The force limiter according to claim 1, wherein
a blocking element which blocks the displacement part is provided, and is movable by means of a controllable actuator from a blocking position into a release position which releases the displacement part.

14. The force limiter according to claim 1, wherein
a blocking element which blocks the tensile transmission element is provided, and is movable by means of a controllable actuator from a blocking position into a release position which releases the tensile transmission element.
